(19) United States
(12) Patent Application Publication
(10) Pub. No.: US 2017/0061134 A1
(43) Pub. Date: Mar. 2, 2017

(54) SYSTEM FOR AUTOMATICALLY GENERATING AN ATTACKER APPLICATION TARGETED TO A VICTIM APPLICATION

(71) Applicant: Wegilant Net Solutions Private Limited, Gurgaon (IN)

(72) Inventors: Toshendra Kumar Sharma, Mumbai (IN); Bhanu Prakash Valluri, Gurgaon (IN)

(21) Appl. No.: 14/880,602

(22) Filed: Oct. 12, 2015

(30) Foreign Application Priority Data
Aug. 26, 2015 (IN) 2659/DEL/2015

(51) Int. Cl. G06F 21/57

(52) U.S. Cl. CPC G06F 21/577; G06F 2221/033

(57) ABSTRACT

A system for automatically generating an attacker application to perform vulnerability analysis on a victim application is disclosed. The system includes a memory unit, a processor that executes the set of modules. The set of modules includes a victim application permissions reading module, a permission obtaining module, a configuration file updating module, and a targeted attacker application creation module. The permission obtaining module is configured to obtain a list of permissions to exploit the victim application based on the list of permissions. The configuration file updating module is configured to update a configuration file of a template attacker application with the list of permissions to generate an attacker application that is specific to the victim application. The targeted attacker application creation module is configured to create the attacker application based on the list of permissions to attack the victim application.

### CROSS-REFERENCE TO RELATED APPLICATIONS

This application claims priority to Indian patent application no. 2659/DEL/2015 filed on Aug. 26, 2015, the complete disclosure of which, in its entirely, is herein incorporated by reference

### BACKGROUND

Technical Field

The embodiments herein generally relate to attacking a mobile application, and more particularly, to a system for automatically generating an attacker application targeted to a victim application.

Description of the Related Art

The tremendous growth of software development and reliance on internet based applications for many aspects of modern life has also opened doors for attackers to inflict serious damage to software systems and steal highly sensitive information, causing heavy financial and/or reputation loss to companies and organizations serving their customers/users through various internet based applications.

Developers often overlook security aspects while designing or implementing software. Building secure software requires security knowledge, more thought and more discipline during design and implementation, which is a long-term investment. However, under pressure for delivering features for business, security aspects may be overlooked or ignored with no immediate consequences. Also, business users normally cannot distinguish between secure and insecure software. The risk introduced however when averaged over large number of applications makes this a short-term gain but a long-term loss. As a result large amount of insecure software is still being produced, which cannot withstand attacks by highly motivated, focused, and technically skilled attackers. The only way to solve such problem properly at a later point in time is to go back to the application source and make the fix. However, if there is a design level flaw then the cost of fixing can be high, often requiring large amount of design change and software rewrite. Businesses are often not willing to invest large amount in securing software later especially when it is difficult to measure or gauge risk of an attack. When a security breach occurs, it becomes difficult to justify why security considerations were not taken in the first place which could have avoided costly financial and/or reputation loss as well as costly fixes.

Defending applications and attacking applications are on two ends of the spectrum. Some companies may only rely on penetration testers and/or black box scanners to identify vulnerabilities in their applications on the assumption that since attackers only have external access to application, using the same approach to identify vulnerabilities would be sufficient. However, there is a serious flaw with this assumption. Whereas an attacker only needs to find and exploit one vulnerability and will look for the easiest one to find and exploit, that is, the weakest link, in order to secure an application, all vulnerabilities need to be identified and fixed.

Further, attackers can spend months with full focus on one suspected behavior of application and plenty of offline study and analysis to find and exploit a single vulnerability, whereas a penetration tester typically only has few weeks per application to find vulnerabilities. Even automated black box scanners can typically find only small portion of actual vulnerabilities. Further, finding all vulnerabilities with external checks only, whether manual or automatic or a combination of both is a scientifically flawed approach.

When it comes to manual testing, there are large number of security categories and vulnerabilities which have to be checked on every use case, which is extremely difficult and time consuming on a large application. When it comes to automated black box scanners, they face many challenges in both efficiently crawling as well as coming up with right data as well as fuzzed data with no guarantee that they have touched every part of software on modern web and complex multi-tiered applications. When it comes to development, every application has its own unique business logic and rules. Human errors inevitably occur and every member of development team may not be expert in security aspects resulting in insecure software. When it comes to threat landscape, software, which is considered secure today, may no longer be considered secure tomorrow as new threats may emerge.

Accordingly, there remains a need for an automated system that can perform vulnerability analysis on an application in an efficient way.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

In one aspect, a system for automatically generating an attacker application to perform vulnerability analysis on a victim application includes a memory unit that stores a database and a set of modules and a processor that executes the set of modules. In an embodiment, the set of modules includes a victim application permissions reading module, a request permission module, a permission obtaining module, a configuration file updating module, and an targeted attacker application creation module. The victim application permissions reading module is configured to read a list of permissions declared by the victim application. The permission obtaining module is configured to obtain the list of permissions to exploit the victim application based on the list of permissions. The configuration file updating module is configured to update a configuration file of a template attacker application with the list of permissions to generate an attacker application that is specific to the victim application. The targeted attacker application creation module is configured to create the attacker application based on the list of permissions to attack the victim application. In an embodiment, the database is configured to store the template attacker application. In an embodiment, the list of permissions includes permissions associated with a framework of the victim application and framework is selected from the group of (i) a content provider, (ii) a broadcast receiver, and (iii) a view system of the victim application. In an embodiment, the attacker application comprises a plurality of attack vectors targeted to attack said victim application based on said list of permissions and the plurality of attack vectors are selected from a group of (i) a SQL injection, (ii) a cross-site scripting (XSS), (iii) a buffer overflows, (iv) a unhandled error conditions, or (v) a potential back-doors of said victim application (i) a SQL injection, (ii) a cross-site scripting (XSS), (iii) a buffer overflows, (iv) a unhandled error conditions, and (v) a potential back-doors of the victim application.

In another aspect, a processor implemented for generating an attacker application targeted to a victim application includes the following steps: (i) reading a list of permissions declared by the victim application, (ii) obtaining the list of permissions to exploit the victim application based on the list of permissions, (iii) updating a configuration file of a template attacker application with the list of permissions to generate an attacker application that is specific to the victim application, and (iv) creating the attacker application based on the list of permissions to exploit the victim application.

In yet another aspect, a non-transitory program storage device readable by computer, and includes a program of instructions executable by the computer to perform a method of generating an attacker application targeted to a victim application includes the following steps: (i) reading a list of permissions declared by the victim application, (ii) obtaining the list of permissions to exploit the victim application based on the list of permissions, (iii) updating a configuration file of a template attacker application with the list of permissions to generate an attacker application that is specific to the victim application, and (iv) creating the attacker application based on the list of permissions to attack the victim application. In an embodiment, a plurality of attack vectors targeted to attack said victim application based on said list of permissions and the attack vectors are selected from a group of (i) a SQL injection, (ii) a cross-site scripting (XSS), (iii) a buffer overflows, (iv) a unhandled error conditions, or (v) a potential back-doors of said victim application.

### BRIEF DESCRIPTION OF THE DRAWINGS

The embodiments herein will be better understood from the following detailed description with reference to the drawings, in which:

FIG. 1 illustrates a system view of an attacker application generation system communicating with a victim application for generating an attacker application for attacking the victim application according to an embodiment herein;

FIG. 2 illustrates an exploded view of the attacker application generation system of FIG. 1 according to an embodiment herein;

FIG. 3 is a flow diagram illustrating a method of automatically generating an attacker application to perform vulnerability analysis on a victim application using the attacker application generation system of FIG. 1 according to an embodiment herein; and

FIG. 4 illustrates a schematic diagram of a computer architecture used according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

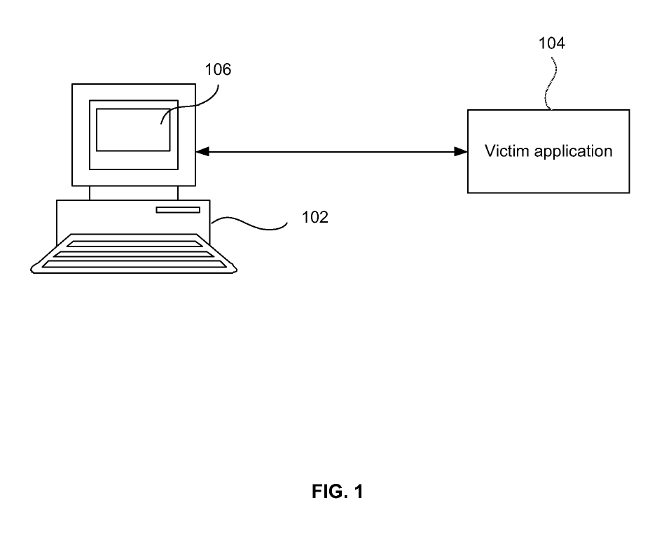

As mentioned, there remains a need of a system for an automated system that can perform vulnerability analysis on an application in an efficient way. The embodiments herein achieve this by providing an attacker application system that automatically generates an attacker application for performing vulnerability analysis on a victim application. Referring now to the drawings, and more particularly to FIGS. 1 through 4, where similar reference characters denote corresponding features consistently throughout the figures, there are shown preferred embodiments.

FIG. 1 illustrates a system view of an attacker application generation system 102 communicating with a victim application 104 for generating an attacker application 106 for attacking the victim application 104 according to an embodiment herein. The attacker application generation system 102 obtains a list of permissions from the victim application 104 to automatically generate an attacker application 106 for the victim application 104 based on the list of permissions. The attacker application 106 performs vulnerability analysis on the victim application 104.

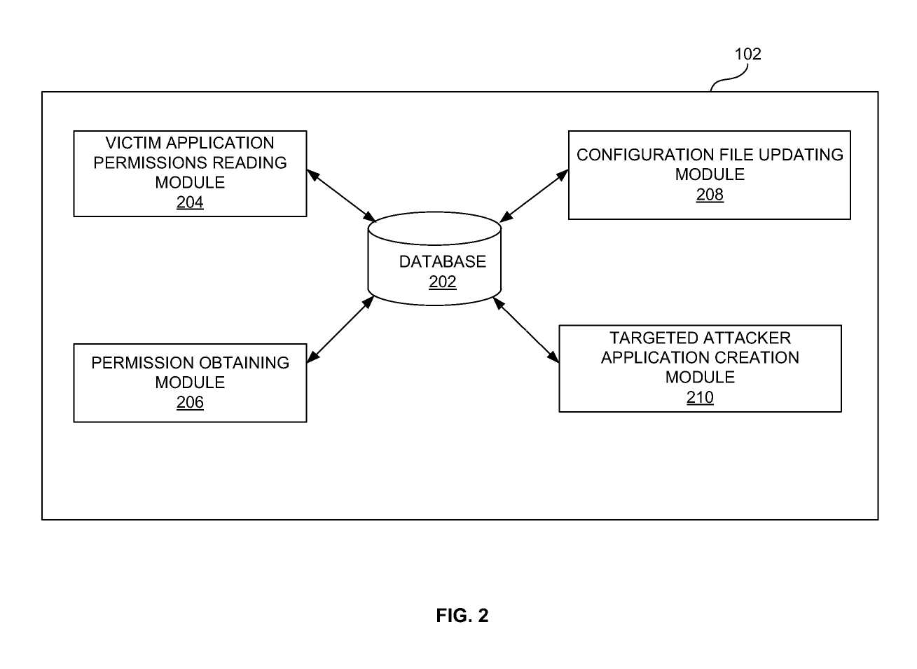

FIG. 2 illustrates an exploded view of attacker application generation system 102 of FIG. 1 according to an embodiment herein. The attacker application generation system 102 includes a database 202 that may include a template attacker application, a victim application permissions reading module 204, a permission obtaining module 206, a configuration file updating module 208, and a targeted attacker application creation module 210. The victim application permissions reading module 204 is configured to read a list of permissions declared by the victim application 104. For example the list of permissions may be a ACCESS_CHECKIN_PROPERTIES that allows read/write access to the “properties” table in the ‘checkin’ database, to change values that get uploaded, a ACCESS_COARSE_LOCATION that allows an app to access approximate location derived from network location sources such as cell towers and Wi-Fi, a ACCESS_FINE_LOCATION that allows an app to access precise location from location sources such as GPS, cell towers, and Wi-Fi, a ACCESS_LOCATION_EXTRA_COMMANDS that allows an application to access extra location provider commands and the like. The permission obtaining module 206 is configured to obtain the list of permissions to exploit the victim application 104 based on the list of permissions.

A pseudo code for obtaining list of permissions is shown below:

<provider
android:name=“com.myapp.mymodule.provider.FetchContentProvider”,
android:readPermission=“com.myapp.fetch.provider.ACCESS”,
android:exported=“true”and
android:authorities=“com.myapp.fetch.provider.FetchContentProvider” />

In one embodiment, the list of permissions includes permissions (e.g., characteristic of the victim application 104) associated with a framework of the victim application 104. In another embodiment, the framework is selected from group of (i) a content provider, (ii) a broadcast receiver, and (iii) a view system of the victim application 104. The configuration file updating module 208 is configured to update a configuration file of a template attacker application with the list of permissions to generate an attacker application 106 that is specific to the victim application 104.

For example the configuration file of the template attacker application is updated as <uses-permission android:name=“com.myapp.fetch.provider.ACCESS”/>. In one embodiment, the database 202 is configured to store the template attacker application. The targeted application creation module 210 is configured to create the attacker application based on the list of permissions to attack the victim application 104. In one embodiment, the attacker application includes a plurality of attack vectors targeted to attack the victim application based on the list of permissions and the plurality of attack vectors are selected from a group of (i) a SQL injection, (ii) a cross-site scripting (XSS), (iii) a buffer overflows, (iv) a unhandled error conditions, or (v) a potential back-doors of said victim application.

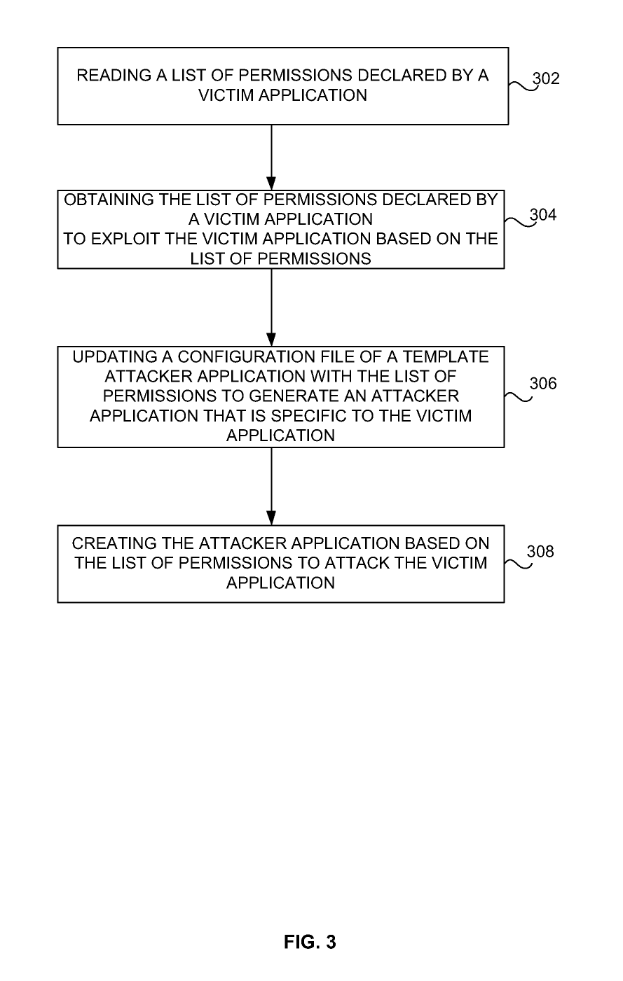

FIG. 3 is a flow diagram illustrating a method of automatically generating an attacker application to perform vulnerability analysis on a victim application using the attacker application generation system 102 of FIG. 1 according to an embodiment herein. At step 302, reading a list of permissions declared by the victim application 104. In one embodiment, the list of permissions includes permissions associated with a framework of the victim application 104. In another embodiment, the framework is selected from a group of (i) a content provider, (ii) a broadcast receiver, and (iii) a view system of the victim application 104. At step 304, obtaining the list of permissions to exploit the victim application 104 based on the list of permissions. At step 306, updating a configuration file of a template attacker application with the list of permissions to generate an attacker application 106 that is specific to the victim application 104. At step 308, configuring to create the attacker application based on the list of permissions to attack the victim application 104. In one embodiment, the attacker application includes a plurality of attack vectors targeted to attack the victim application based on the list of permissions and the plurality of attack vectors are selected from a group of (i) a SQL injection, (ii) a cross-site scripting (XSS), (iii) a buffer overflows, (iv) a unhandled error conditions, or (v) a potential back-doors of the victim application.

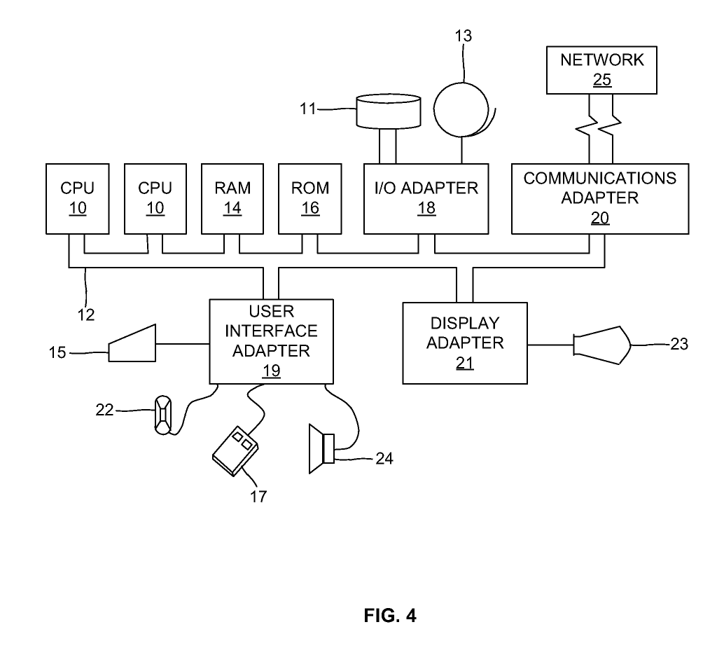

A representative hardware environment for practicing the embodiments herein is depicted in FIG. 4. This schematic drawing illustrates a hardware configuration of an information handling/computer system in accordance with the embodiments herein. The system includes at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for automatically generating an attacker application targeted to a victim application, comprising:
a memory unit that stores a database that comprises a template attacker application, a set of modules and instructions; and
a processor which when configured by said instructions executes said set of modules, wherein said set of modules comprise:
a victim application permissions reading module, implemented by said processor, that reads a list of permissions associated with a framework of said victim application that are declared in said victim application;
a permission obtaining module, implemented by said processor, that obtains said list of permissions to exploit said victim application based on said list of permissions;
a configuration file updating module, implemented by said processor, that updates a configuration file of said template attacker application with said list of permissions to generate an attacker application that is specific to said victim application; and
a targeted attacker application creation module, implemented by said processor, that creates said attacker application, wherein said attacker application comprises a plurality of attack vectors targeted to attack said victim application based on said list of permissions.

2. The system of claim 1, wherein said list of permissions comprises permissions associated with said framework of said victim application, wherein said framework is selected from a group comprising (i) a content provider, (ii) a broadcast receiver, and (iii) a view system of said victim application.

3. The system of claim 1, wherein said plurality of attack vectors are selected from a group comprising (i) a SQL injection, (ii) a cross-site scripting (XSS), (iii) a buffer overflows, (iv) a unhandled error conditions, or (v) a potential back-doors of said victim application.

4. A processor implemented method for generating an attacker application targeted to a victim application, said method comprising:
reading a list of permissions declared by said victim application, wherein said list of permissions comprises permissions associated with a framework of said victim application, wherein said framework is selected from a group comprising (i) a content provider, (ii) a broadcast receiver, and (iii) a view system of said victim application;
obtaining said list of permissions to exploit said victim application based on said list of permissions;
updating a configuration file of a template attacker application with said list of permissions that are specific to said victim application; and
creating said attacker application that comprises a plurality of attack vectors targeted to attack said victim application based on said list of permissions.

5. The processor implemented method of claim 4, wherein said attack vectors are selected form a group comprising (i) a SQL injection, (ii) a cross-site scripting (XSS), (iii) a buffer overflows, (iv) a unhandled error conditions, or (v) a potential back-doors of said victim application.

6. One or more non-transitory computer readable storage mediums storing one or more sequences of instructions, which when executed by one or more processors, creates an attacker application targeted to a victim application, performing the steps of:
reading a list of permissions declared by said victim application, wherein said list of permissions comprises permissions associated with a framework of said victim application, wherein said framework is selected from a group comprising (i) a content provider, (ii) a broadcast receiver, and (iii) a view system of said victim application;
obtaining said list of permissions to exploit said victim application based on said list of permissions;
updating a configuration file of a template attacker application with said list of permissions that are specific to said victim application; and
creating said attacker application that comprises a plurality of attack vectors that are selected from a group comprising (i) a SQL injection, (ii) a cross-site scripting (XSS), (iii) a buffer overflows, (iv) a unhandled error conditions, or (v) a potential back-doors of said victim application, wherein said attack vectors are targeted to said list of permissions declared in said victim application.
